(19) United States
(12) Patent Application Publication
(10) Pub. No.: US 2023/0375683 A1
(43) Pub. Date: Nov. 23, 2023

(54) OPTICAL UNIT, TEST SYSTEM, AND METHOD FOR PRODUCING AN OPTICAL UNIT

(71) Applicant: dSPACE GmbH, Paderborn (DE)

(72) Inventors: Andreas Himmler, Paderborn (DE); Stefan Schukat, Paderborn (DE); Gregor Sievers, Paderborn (DE); Rainer Wolsfeld, Paderborn (DE); Jens Hagemeyer, Bielefeld (DE); Dirk Jungewelter, Bielefeld (DE); Jan Lachmair, Bielefeld (DE)

(21) Appl. No.: 18/187,696

(22) Filed: Mar. 22, 2023

(30) Foreign Application Priority Data
May 23, 2022 (DE) 102022112920.9

(51) Int. Cl. G01S 7/497; G01S 7/481

(52) U.S. Cl. CPC G01S 7/497; G01S 7/4815; G01S 7/4818

(57) ABSTRACT

An optical unit for transmitting a synthetically generated optical signal for a test system of a LiDAR sensor includes: a carrier device for accommodating at least one optical waveguide, wherein the carrier device has at least one opening which is formed orthogonally to an end face of the carrier device and into which the at least one optical waveguide is inserted; and at least one microlens connected to the end face of the carrier device. End faces of the carrier device that face each other and of the at least one microlens each have a planar design. The at least one microlens is assigned to the at least one optical waveguide inserted into the at least one opening of the carrier device. The synthetically generated optical signal transmitted by the at least one optical waveguide is directed through the assigned microlens to the LiDAR sensor.

### CROSS-REFERENCE TO PRIOR APPLICATIONS

Priority is claimed to German Patent Application No. DE 102022112920.9, filed on May 23, 2022, the entire disclosure of which is hereby incorporated by reference herein.

### FIELD

The present invention relates to an optical unit for transmitting a synthetically generated optical signal for a test system of a LiDAR sensor.

The present invention further relates to a test system for a LiDAR sensor.

In addition, the invention relates to a method of producing an optical unit for transmitting a synthetically generated optical signal for a test system of a LiDAR sensor.

### BACKGROUND

LiDAR light measuring systems are used in addition to other applications for optical distance and speed measurement. LiDAR light measuring systems emit light and measure the transit time in which the light returns to the LiDAR light measuring system after reflecting against an object. The distance of the object from the LiDAR light measuring system is derived from the known speed of light.

Examples of fields of application of LiDAR light measuring systems are mobile instruments for optical distance measurement and LiDAR light measuring systems for the automotive field, viz., driver assistance systems and autonomous driving, as well as for aerospace applications.

DE 102007057372 A1 describes a test system for lidar sensors having a trigger unit, by means of which a signal generator is controlled in response to the reception of a signal of a lidar sensor to be tested such that a predetermined, synthetically generated or recorded optical signal is output by a signal generating unit of the signal generator.

DE 102017110790 A1 describes a simulation device for a LiDAR light measuring system having a LiDAR light receiving sensor, wherein a light transmitter is present in the plane of the LiDAR light receiving sensor, wherein a further light transmitter is arranged next to the light transmitter in the plane of the LiDAR light receiving sensor, and wherein a computer monitors the enabling of the LiDAR light receiving sensor and the time period for emitting a light signal via the light transmitter and/or the further light transmitter and records the signal input of the light signal from the light transmitter or the further light transmitter.

One problem when testing LiDAR sensors using a signal generator is that all light sources or pixels of the signal generator or LiDAR OTA system must be superimposed in one point. This point ideally corresponds to an aperture diaphragm of the LiDAR sensor to be tested.

The problem is to transfer this targeted beam guidance to the signal generator, taking into account economic perspectives.

### SUMMARY

In an exemplary embodiment, the present invention provides an optical unit for transmitting a synthetically generated optical signal for a test system of a LiDAR sensor. The optical unit comprises: a carrier device for accommodating at least one optical waveguide, wherein the carrier device has at least one opening which is formed orthogonally to an end face of the carrier device and into which the at least one optical waveguide is inserted; and at least one microlens connected to the end face of the carrier device. End faces of the carrier device that face each other and of the at least one microlens each have a planar design. The at least one microlens is assigned to the at least one optical waveguide inserted into the at least one opening of the carrier device. The synthetically generated optical signal transmitted by the at least one optical waveguide is directed through the assigned microlens to the LiDAR sensor. The at least one optical waveguide is arranged, in the carrier device, offset with respect to an optical axis of the microlens that is assigned to the at least one optical waveguide.

### BRIEF DESCRIPTION OF THE DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 depicts a schematic illustration of an optical unit for transmitting a synthetically generated optical signal for a test system of a LiDAR sensor according to a first embodiment of the invention;

FIG. 2 depicts a schematic illustration of the optical unit for transmitting the synthetically generated optical signal for the test system of the LiDAR sensor according to a second embodiment of the invention;

FIG. 3 depicts a schematic illustration of a test system of the LiDAR sensor according to embodiments of the invention;

FIG. 4 depicts a plan view of the test system of the LiDAR sensor according to embodiments of the invention; and

FIG. 5 depicts a method for producing an optical unit for transmitting a synthetically generated optical signal for a test system of a LiDAR sensor according to embodiments of the invention.

Unless otherwise indicated, the same reference signs denote the same elements of the drawings.

### DETAILED DESCRIPTION

Exemplary embodiments of the invention provide an optical unit for transmitting a synthetically generated optical signal for a test system of a LiDAR sensor, which unit enables targeted beam guidance within the scope of an optimized cost-benefit ratio.

Exemplary embodiments of the invention include an optical unit for transmitting a synthetically generated optical signal for a test system of a LiDAR sensor, an alternative optical unit for transmitting a synthetically generated optical signal for a test system of a LiDAR sensor, a test system for a LiDAR sensor, and a method for producing an optical unit for transmitting a synthetically generated optical signal for a test system of a LiDAR sensor.

The invention relates to an optical unit for transmitting a synthetically generated optical signal for a test system of a LiDAR sensor.

The optical unit comprises a carrier device for accommodating at least one optical waveguide, wherein the carrier device has at least one opening which is formed orthogonally to an end face of the carrier device and into which the at least one optical waveguide is inserted.

The optical unit further comprises at least one microlens connected to the end face of the carrier device, wherein the end faces of the carrier device that face each other and of the at least one microlens each have a planar design, wherein the at least one microlens is assigned to the at least one optical waveguide inserted into the at least one opening of the carrier device.

The synthetically generated optical signal transmitted by the at least one optical waveguide—in particular, a laser pulse or a light-emitting diode signal—is directed to a LiDAR sensor through the assigned microlens. The at least one optical waveguide is arranged offset in the carrier device with respect to an optical axis of the microlens assigned to the optical waveguide.

The invention further relates to an alternative optical unit for transmitting a synthetically generated optical signal for a test system of a LiDAR sensor.

The optical unit comprises a carrier device for accommodating at least one optical waveguide, wherein the carrier device has at least one opening formed orthogonally to an end face of the carrier device, into which opening at least one optical waveguide is inserted.

Furthermore, the optical unit comprises at least one microlens connected to the end face of the carrier device, wherein the end faces of the carrier device that face each other and of the at least one microlens each have a planar design, wherein the at least one microlens is assigned to the at least one optical waveguide inserted into the at least one opening of the carrier device.

The at least one optical waveguide is arranged on an optical axis of the at least one microlens assigned to the optical waveguide.

The at least one microlens is further configured to collimate the synthetically generated optical signal transmitted by the at least one optical waveguide—in particular, a laser pulse or a light-emitting diode signal—onto a further lens arranged adjacent to the at least one microlens. Moreover, the synthetically generated optical signal is directed to a LiDAR sensor through the further lens.

Furthermore, the invention relates to a test system for a LiDAR sensor. The test system comprises a plurality of optical units according to the invention—in particular, units arranged to be stationary or movable relative to a LiDAR sensor—as well as a LiDAR sensor to which the synthetically generated optical signal transmitted through the optical units is directed, wherein the plurality of optical units are arranged in a detection region of the LiDAR sensor.

The invention further relates to a method for producing an optical unit for transmitting a synthetically generated optical signal for a test system of a LiDAR sensor.

The method comprises providing a carrier device for accommodating at least one optical waveguide and introducing at least one opening into the carrier device which is formed orthogonally to an end face of the carrier device.

Furthermore, the method comprises inserting the at least one optical waveguide into the at least one opening and fixing the at least one optical waveguide in the at least one opening through a sleeve, and a planar grinding of the end face, facing the lens, of the at least one optical waveguide.

Moreover, the method comprises polishing a fiber end of the at least one optical waveguide and joining and adhering the carrier device to the at least one microlens.

The present invention enables a miniaturization of the optical front end of LiDAR OTA (over the air) test systems by providing the at least one microlens connected to the end face of the carrier device, as well as the offset arrangement of the at least one optical waveguide in the carrier device with respect to the optical axis of the microlens assigned to the optical waveguide.

The optical unit according to the invention further enables an increase in pixel density and angular resolution, without the need to increase a distance to the LiDAR test sensor.

Thus, the feasibility of scalable, monolithic front end modules for flexible adaptation of the OTA test system to customer requirements can also be improved. The OTA test system can be implemented as either stationary or as mechanically movable front end modules or optical units.

Due to the modular design of the OTA test system comprising a plurality of optical units, the use of microlens arrays can be realized in an advantageous manner from an economic perspective.

According to an embodiment of the invention, it is provided that the at least one optical waveguide inserted into the at least one opening of the carrier device be arranged to be parallel, and in particular orthogonally offset, with respect to the optical axis of the at least one microlens.

The offset arrangement of the optical waveguide advantageously enables a deflection of the optical signal through the at least one microlens of the optical unit, so that the optical signal can be exactly aligned with the LiDAR sensor.

According to an embodiment of the invention, it is provided that a dimensioning of the at least one microlens be configured such that a length of a signal path of the synthetically generated optical signal within the at least one microlens corresponds to a focal length of the microlens. Thus, the optical signal is correspondingly directed in the desired direction after exiting the microlens.

According to an embodiment of the invention, it is provided that the further lens be arranged at a predetermined distance from the at least one microlens along the optical axis of the microlens, wherein the further lens is convex at an exit side of the synthetically generated optical signal. This advantageously enables a deflection of the optical signal in the direction of the LiDAR sensor.

According to an embodiment of the invention, it is provided that the at least one microlens be formed in one piece—in particular, from plastic or glass—and wherein the at least one microlens is convex on an exit side of the synthetically generated optical signal. This advantageously enables a deflection of the optical signal in the direction of the LiDAR sensor.

According to an embodiment of the invention, it is provided that the at least one optical waveguide be fixed by a sleeve, and in particular a ferrule, in the at least one opening formed in the carrier device, wherein the sleeve is pressed or glued to the respective optical waveguide and/or the respective opening.

As a result, the optical waveguide can be positioned exactly in the opening. Even after curing of an adhesive, there is thus no change in position of the optical waveguide in the opening.

According to an embodiment of the invention, it is provided that an axial end portion—in particular, of planar design—of the at least one optical waveguide be arranged on the end face, facing the carrier device, of the at least one microlens—in particular, resting against the end face of the at least one microlens. This enables an efficient transmission of the optical signal from the optical waveguide to the microlens, without the occurrence of scattered light losses.

According to an embodiment of the invention, it is provided that the optical unit have a substantially strip-shaped design, and wherein the optical unit is equipped with a plurality of rows of microlenses oriented in the longitudinal direction and in the transverse direction. By providing the plurality of optical waveguides, a higher pixel resolution of the optical unit can thus advantageously be achieved.

According to an embodiment of the invention, it is provided that the plurality of optical units be arranged adjacent to each other, in a substantially semi-circular shape, around the LiDAR sensor. Thus, the test system can simulate a real traffic situation with an identical detection range of the LiDAR sensor.

According to an embodiment of the invention, it is provided that the optical units be configured to deflect, and in particular to refract, a synthetically generated optical signal fed through the optical waveguide by up to 20° with respect to an orientation of the optical waveguides. This advantageously corresponds to an opening angle of the LiDAR sensor of 20°.

According to an embodiment of the invention, provision is made for variably fitting the optical units with microlenses as a function of a position of the respective optical unit relative to the LiDAR sensor. Thus, an optimal lens arrangement for different traffic situations can be made possible.

According to an embodiment of the invention, it is provided that an optical unit arranged in a central portion of the substantially semicircular arrangement of the optical units around the LiDAR sensor have a larger number of microlenses than optical units positioned in edge regions of the semicircular arrangement. This enables a finer resolution for, for example, freeway travel than for traffic situations in an urban region.

Features of the method described herein for determining a computation effort of a virtual test of a device for at least partially autonomous guidance of a motor vehicle are also applicable to the test unit according to the invention for determining a computation effort of a virtual test of a device for at least partially autonomous guidance of a motor vehicle, and vice versa.

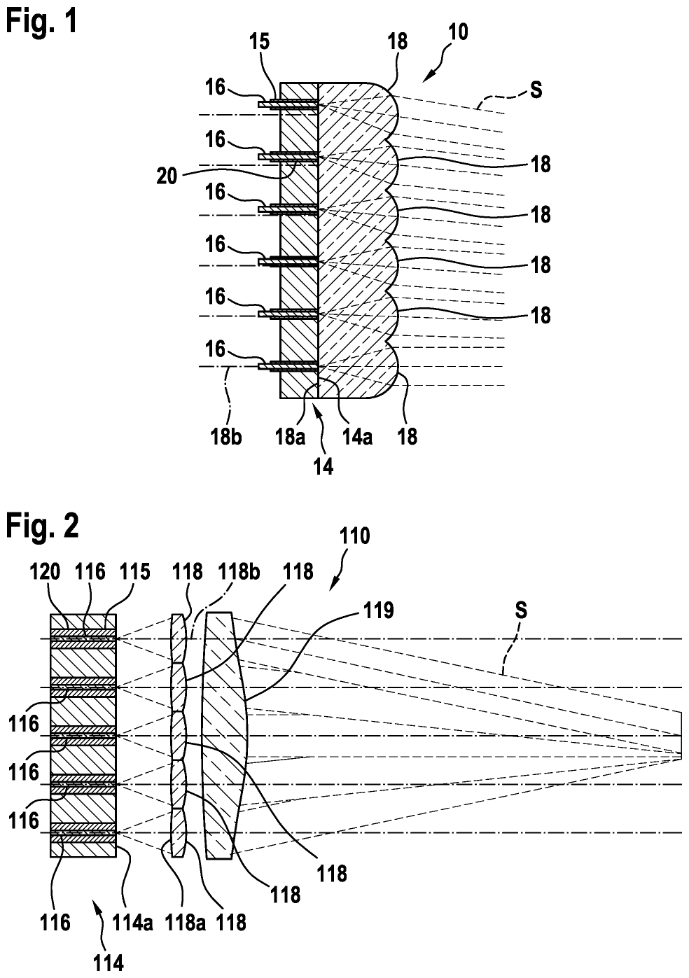

The optical unit 10 shown in FIG. 1 for the transmitting a synthetically generated optical signal S for a test system 1 of a LiDAR sensor 12 comprises a carrier device 14 for accommodating at least one optical waveguide 16.

The carrier device 14 has at least one opening 20 which is formed orthogonally to an end face 14a of the carrier device 14 and into which the at least one optical waveguide 16 is inserted.

The optical unit 10 further has at least one microlens 18 connected to the end face 14a of the carrier device 14.

A number of microlenses 18 per optical unit 10 can be freely selected or configured. For example, a microlens 18 can be assigned to each optical waveguide 16.

In the present embodiment, the carrier device 14 has a plurality of openings 20, wherein an optical waveguide 16 is inserted into each of the openings. A microlens 18 is in turn assigned to each optical waveguide 16.

The end faces 14a, 18a of the carrier device 14 that face each other and of the at least one microlens 18 each have a planar design. The at least one microlens 18 is assigned to the at least one optical waveguide 16 inserted into the at least one opening 20 of the carrier device 14.

The synthetically generated optical signal S transmitted by the at least one optical waveguide 16—in particular, a laser pulse or a light-emitting diode signal—is directed to a LiDAR sensor 12 through the assigned microlens 18.

The at least one optical waveguide 16 is further arranged, in the carrier device 14, offset with respect to an optical axis 18b of the microlens 18 assigned to the optical waveguide 16. The at least one optical waveguide 16 inserted into the at least one opening 20 of the carrier device 14 is further arranged to be parallel, and in particular orthogonally offset, with respect to the optical axis 18b of the at least one microlens 18.

A dimension of the at least one microlens 18 is moreover configured such that a length of a signal path of the synthetically generated optical signal S within the at least one microlens 18 corresponds to a focal length of the microlens 18.

The at least one microlens 18 is formed in one piece, and in particular from plastic or glass. Furthermore, the at least one microlens 18 is convex at an exit side of the synthetically generated optical signal S.

The at least one optical waveguide 16 is fixed by a sleeve 15, and in particular a ferrule, in the at least one opening 20 formed in the carrier device 14. The sleeve 15 is pressed or glued to the respective optical waveguide 16 and/or the respective opening 20.

An axial end portion, configured in particular in a planar manner, of the at least one optical waveguide 16 is also arranged on the end face, facing the carrier device 14, of the at least one microlens 18—in particular, resting against the end face of the at least one microlens 18.

The optical unit 10 has a substantially strip-shaped design. Furthermore, the optical unit 10 is fitted with a plurality of rows of microlenses 18 oriented in the longitudinal direction and in the transverse direction.

FIG. 2 shows a schematic illustration of the optical unit 110 for transmitting the synthetically generated optical signal S for the test system 101 of the LiDAR sensor 112 according to a second embodiment of the invention.

The optical unit 110 comprises a carrier device 114 for accommodating at least one optical waveguide 116, wherein the carrier device 114 has at least one opening 120 which is formed orthogonally to an end face 114a of the carrier device 114 and into which at least one optical waveguide 116 is inserted.

The optical unit 110 further comprises at least one microlens 118 connected to the end face 114a of the carrier device 114. The end faces 114a, 118a of the carrier device 114 that face each other and of the at least one microlens 118 each have a planar design. The at least one microlens 118 is assigned to the at least one optical waveguide 116 inserted into the at least one opening 120 of the carrier device 114.

The at least one optical waveguide 116 is further arranged on an optical axis 118b of the at least one microlens 118 assigned to the optical waveguide 116. Moreover, the at least one microlens 118 is configured to collimate the synthetically generated optical signal S transmitted by the at least one optical waveguide 116—in particular, a laser pulse or a light-emitting diode signal—onto a further lens 119 arranged adjacent to the at least one microlens 118.

The synthetically generated optical signal S is further directed to a LiDAR sensor 112 through the further lens 119. Moreover, the further lens 119 is arranged at a predetermined distance from the at least one microlens 118 along the optical axis 118b of the microlens 118. The further lens 119 is convex at an exit side of the synthetically generated optical signal S.

A number of microlenses 118 per optical unit 110 can be freely selected or configured. For example, a microlens 118 can be assigned to each optical waveguide 116.

In the present embodiment, the carrier device 114 has a plurality of openings 120, wherein an optical waveguide 116 is inserted into each of the openings. A microlens 118 is in turn assigned to each optical waveguide 116.

The at least one microlens 118 is formed in one piece, and in particular from plastic or glass. The at least one microlens 118 is, further, convex at an exit side of the synthetically generated optical signal S.

The at least one optical waveguide 116 is fixed by a sleeve 115, and in particular a ferrule, in the at least one opening 120 formed in the carrier device 114. The sleeve 115 is pressed or glued to the respective optical waveguide 116 and/or the respective opening 120.

An axial end portion—in particular, having a planar design—of the at least one optical waveguide 116 is arranged on the end face, facing the carrier device 114, of the at least one microlens 118—in particular, resting against the end face of the at least one microlens 118. Furthermore, the optical unit has a substantially strip-shaped design, and the optical unit is fitted with a plurality of rows of microlenses 118 oriented in the longitudinal direction and in the transverse direction.

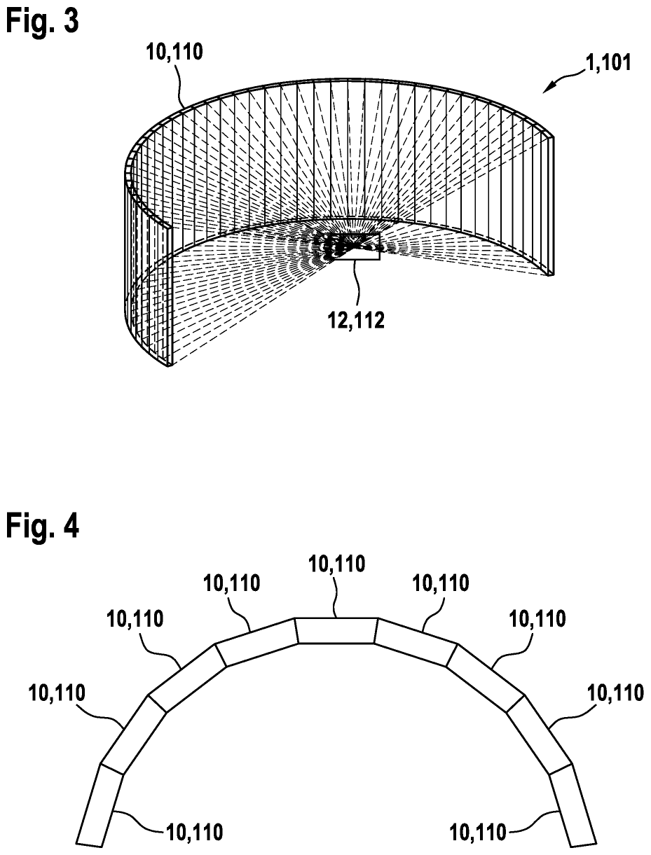

FIG. 3 is a schematic illustration of a test system 1; 101 of the LiDAR sensor 12; 112 according to embodiments of the invention.

The test system 1; 101 for the LiDAR sensor 12; 112 comprises a plurality of optical units 10; 110 according to the invention—in particular, arranged to be stationary or movable relative to a LiDAR sensor 12; 112—as well as a LiDAR sensor 12; 112 to which the synthetically generated optical signal S transmitted through the optical units 10; 110 is directed. The plurality of optical units are further arranged in a detection region of the LiDAR sensor 12; 112.

The plurality of optical units 10; 110 are adjacent to each other, in a substantially semicircular configuration, around the LiDAR sensor 12; 112. The optical units here are configured to deflect, and in particular to refract, the synthetically generated optical signal S fed through the optical waveguide 16; 116 by up to 20° with respect to an orientation of the optical waveguides 16; 116.

FIG. 4 shows a plan view of the test system 1; 101 of the LiDAR sensor 12; 112 according to embodiments of the invention.

A fitting of the optical units 10; 110 with microlenses 18; 118 is variable as a function of a position of the respective optical unit 10; 110 relative to the LiDAR sensor 12; 112.

An optical unit 10; 110 arranged in a central portion of the substantially semicircular arrangement of the optical units 10; 110 around the LiDAR sensor 12; 112 preferably has a larger number of microlenses 18; 118 than optical units 10; 110 positioned in edge regions of the semicircular arrangement. Alternatively, the arrangement can take place according to other structural and/or systemic criteria.

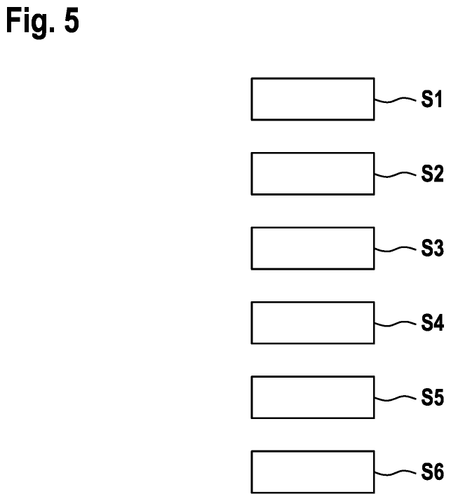

FIG. 5 shows a method for manufacturing an optical unit for transmitting a synthetically generated optical signal S for a test system 1 of a LiDAR sensor 12; 112 according to embodiments of the invention.

The method comprises providing S1 a carrier device 14; 114 for accommodating at least one optical waveguide 16; 116 and introducing S2 at least one opening 20; 120—formed orthogonally with respect to an end face 14a; 114a of the carrier device 14; 114—into the carrier device 14; 114.

Furthermore, the method comprises inserting S3 the at least one optical waveguide 16; 116 into the at least one opening 20; 120 and fixing the at least one optical waveguide 16; 116 in the at least one opening 20; 120 by a sleeve 15; 115, and a planar grinding S4 of the end face, facing the lens, of the at least one optical waveguide 16; 116.

The method further comprises polishing S5 a fiber end of the at least one optical waveguide 16; 116 and joining S6 and adhering the carrier device 14; 114 to the at least one microlens 18; 118.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1; 101 Test system
10; 110 Optical unit
12; 112 LiDAR sensor
14; 114 Carrier device
14a; 114a End face
15; 115 Sleeve
16; 116 Optical waveguide
18; 118 Microlens
18a; 118a End faces
18b; 118b Optical axis
119 Further lens
20; 120 Opening
S Optical signal
S1-S6 Method steps

1. An optical unit for transmitting a synthetically generated optical signal for a test system of a LiDAR sensor, comprising:
a carrier device for accommodating at least one optical waveguide, wherein the carrier device has at least one opening which is formed orthogonally to an end face of the carrier device and into which the at least one optical waveguide is inserted; and
at least one microlens connected to the end face of the carrier device, wherein end faces of the carrier device that face each other and of the at least one microlens each have a planar design, wherein the at least one microlens is assigned to the at least one optical waveguide inserted into the at least one opening of the carrier device, wherein the synthetically generated optical signal transmitted by the at least one optical waveguide is directed through the assigned microlens to the LiDAR sensor, and wherein the at least one optical waveguide is arranged, in the carrier device, offset with respect to an optical axis of the microlens that is assigned to the at least one optical waveguide.

2. The optical unit according to claim 1, wherein the at least one optical waveguide inserted into the at least one opening of the carrier device is arranged to be parallel with respect to the optical axis of the at least one microlens.

3. The optical unit according to claim 1, wherein a dimension of the at least one microlens is configured such that a length of a signal path of the synthetically generated optical signal within the at least one microlens corresponds to a focal length of the microlens.

4. The optical unit according to claim 1, wherein the at least one microlens is integrally formed, wherein the at least one microlens is made of plastic or glass, and wherein the at least one microlens is convex at an exit side of the synthetically generated optical signal.

5. The optical unit according to claim 1, wherein the at least one optical waveguide is fixed by a sleeve in the at least one opening formed in the carrier device, wherein the sleeve is a ferrule, and wherein the sleeve is pressed or glued to a respective optical waveguide and/or a respective opening.

6. The optical unit according to claim 1, wherein an axial end portion, configured in a planar manner, of the at least one optical waveguide is arranged on an end face, facing the carrier device, of the at least one microlens resting against an end face of the at least one microlens.

7. The optical unit according to claim 1, wherein the optical unit has a substantially strip-shaped design, and wherein the optical unit is fitted with a plurality of rows of microlenses aligned in the longitudinal direction and in the transverse direction.

8. The optical unit according to claim 1, wherein the optical unit is part of a test system for the LiDAR sensor, the test system comprising:
a plurality of optical units, arranged to be stationary or movable relative to the LiDAR sensor; and
the LiDAR sensor to which the synthetically generated optical signal transmitted through the optical units is directed;
wherein the plurality of optical units are arranged in a detection region of the LiDAR sensor.

9. An optical unit for transmitting a synthetically generated optical signal for a test system of a LiDAR sensor, comprising:
a carrier device for accommodating at least one optical waveguide, wherein the carrier device has at least one opening which is formed orthogonally to an end face of the carrier device and into which at least one optical waveguide is inserted; and
at least one microlens connected to the end face of the carrier device, wherein end faces of the carrier device that face each other and of the at least one microlens each have a planar design, wherein the at least one microlens is assigned to the at least one optical waveguide inserted into the at least one opening of the carrier device, wherein the at least one optical waveguide is arranged on an optical axis of the at least one microlens assigned to the at least one optical waveguide, wherein the at least one microlens is configured to collimate the synthetically generated optical signal transmitted by the at least one optical waveguide onto a further lens arranged adjacent to the at least one microlens, and wherein the synthetically generated optical signal is directed through the further lens to the LiDAR sensor.

10. The optical unit according to claim 9, wherein the further lens is arranged at a predetermined distance from the at least one microlens along the optical axis of the microlens, wherein the further lens is convex at an exit side of the synthetically generated optical signal.

11. The optical unit according to claim 9, wherein the at least one microlens is integrally formed and wherein the at least one microlens is convex at an exit side of the synthetically generated optical signal.

12. The optical unit according to claim 9, wherein the at least one optical waveguide is fixed by a sleeve in the at least one opening formed in the carrier device, wherein the sleeve is pressed or glued to a respective optical waveguide and/or a respective opening.

13. The optical unit according to claim 9, wherein an axial end portion, of the at least one optical waveguide is arranged on an end face, facing the carrier device, of the at least one microlens resting against an end face of the at least one microlens.

14. The optical unit according to claim 9, wherein the optical unit has a substantially strip-shaped design, and wherein the optical unit is fitted with a plurality of rows of microlenses aligned in the longitudinal direction and in the transverse direction.

15. The optical unit according to claim 9, wherein the optical unit is part of a test system for the LiDAR sensor, the test system comprising:
a plurality of optical units, arranged to be stationary or movable relative to a LiDAR sensor; and
the LiDAR sensor to which the synthetically generated optical signal transmitted through the optical units is directed;
wherein the plurality of optical units are arranged in a detection region of the LiDAR sensor.

16. The optical unit according to claim 15, wherein the plurality of optical units are arranged adjacent to each other, in a substantially semi-circular shape, around the LiDAR sensor.

17. The optical unit according to claim 15, wherein the optical units are configured to deflect and refract a synthetically generated optical signal fed through the at least one optical waveguide by up to 20° with respect to an orientation of the at least one optical waveguide.

18. The optical unit according to claim 15, wherein a fitting of the optical units with microlenses is variable as a function of a position of a respective optical unit relative to the LiDAR sensor.

19. The optical unit according to claim 18, wherein an optical unit arranged in a central portion of a substantially semicircular arrangement of the optical units around the LiDAR sensor has a larger number of microlenses than optical units positioned in edge regions of the semicircular arrangement.

20. A method for producing an optical unit for transmitting a synthetically generated optical signal for a test system of a LiDAR sensor, comprising:
providing a carrier device for accommodating at least one optical waveguide;
introducing into the carrier device at least one opening formed orthogonally to an end face of the carrier device;
inserting the at least one optical waveguide into the at least one opening and fixing the at least one optical waveguide in the at least one opening through a sleeve;
planar grinding of the end face, facing the lens, of the at least one optical waveguide;
polishing a fiber end of the at least one optical waveguide; and
joining and adhering the carrier device to the at least one microlens.
